(19) United States
(12) Patent Application Publication
(10) Pub. No.: US 2007/0082241 A1
(43) Pub. Date: Apr. 12, 2007

(54) Fuel cell apparatus of feedback module

(76) Inventors: Hsi-Ming Shu, Taipei (TW); Feng-Yi Deng, Taipei (TW); Tsang-Ming Chang, Taipei (TW); Chien-Lang Wang, Taipei (TW); Yu Lin Tang, Taipei (TW)

Correspondence Address: G. LINK Co., LTD, 3550 Bell Road, MINOOKA, IL, 60447, US

(21) Appl. No.: 11/245,005

(22) Filed: Oct. 7, 2005

(51) Int. Cl. H01M 8/04

(52) U.S. Cl. 429/22; 429/24

(57) ABSTRACT

The present invention is a fuel cell apparatus of feedback module which comprises at least one fuel cell unit and energy management unit. The energy management unit used to manage the power efficiency of the fuel cell unit at least comprises the following components: sensing module, which is used to at least sense the temperature variation of the fuel, the liquid level variation of the fuel, the concentration variation of the fuel utilized in the electrochemical reaction proceeded by the fuel cell unit, and used to produce the corresponding sensed signals to these variations; I/O interface, which is used to provide the conducting paths for the signal and the electrical power; constant voltage module, which is used to connect the fuel cell unit and receive the electrical power produced by the fuel cell unit and then output a stable voltage of power supply; microprocessor, which is used to manage the power efficiency of the fuel cell unit based on these sensed signals and the signal received from I/O interface; electrical loop, which is used to connect the fuel cell unit, sensing module, I/O interface, constant voltage module and microprocessor.

### FIELD OF THE INVENTION

The present invention is related to a fuel cell, especially to a fuel cell apparatus of feedback module, which integrates an energy management unit and fuel cell by the circuit board to be the fuel cell with energy management.

### BACKGROUND OF THE INVENTION

The used fuel cell uses the fuel with hydrogen like methanol to form the current loop as the power source by an oxidation-reduction reaction. The reactant needed by this kind of fuel cell has liquid fuel like methanol fuel, and the main product after reaction is water and carbon-dioxide so as to make the fuel cell have the container structure filled with liquid fuel and the mechanism to drive fuel flow. The general fuel cell needs stable conditions in fuel concentration, fuel flux and feasible temperature to get better efficiency of energy production, but the used kind of fuel cell does not have any sensor or control for related conditions. Therefore, the present invention is based on the disadvantages of used fuel cells and desires improvement to invent a fuel cell apparatus of feedback module.

### SUMMARY OF THE INVENTION

The first object of the present invention is to provide a fuel cell apparatus of a single board with the capability of managing energy and outputting a stable voltage.

The second object of the present invention is to provide a fuel cell apparatus of a single board able to feedback the current condition of the fuel cell and output a stable voltage.

To achieve the above objects, the present invention provides a fuel cell apparatus of feedback module comprising: at least one fuel cell unit; an energy management unit used to manage the power efficiency of the fuel cell unit at least comprises: a sensing module, which is used to at least sense the temperature variation of the fuel, the liquid level variation of the fuel, the concentration variation of the fuel utilized in the electrochemical reaction proceeded by the fuel cell unit, and used to produce the corresponding sensed signals to these variations; an I/O interface, which is used to provide the conducting paths for the signal and the electrical power; constant voltage module, which is used to connect the fuel cell unit and receive the electrical power produced by the fuel cell unit and then output a stable voltage of power supply; a microprocessor, which is used to manage the power efficiency of the fuel cell unit based on these sensed signals and the signal received from I/O interface; an electrical loop, which is used to electrically connect the fuel cell unit, sensing module, I/O interface, constant voltage module and microprocessor.

### BRIEF DESCRIPTION OF THE DRAWINGS

The above objects and advantages of the present invention will become more apparent with reference to the appended drawings wherein:

FIG. 1 shows the structural figure of the fuel cell apparatus of feedback module of the present invention;

FIG. 2 shows the block diagram of the fuel cell apparatus of feedback module of the present invention;

FIG. 3 shows the embodiment of the fuel cell apparatus of feedback module of the present invention;

FIG. 4A shows the embodiment of the I/O interface of the present invention; and

FIG. 4B shows another embodiment of the I/O interface of the present invention.

### DETAILED DESCRIPTION OF THE INVENTION

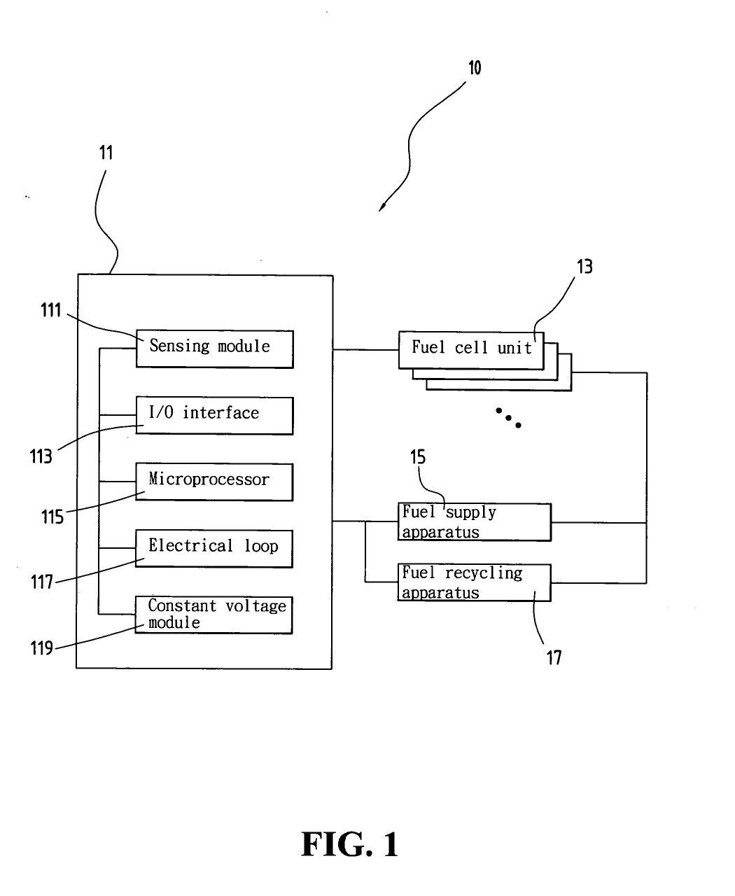

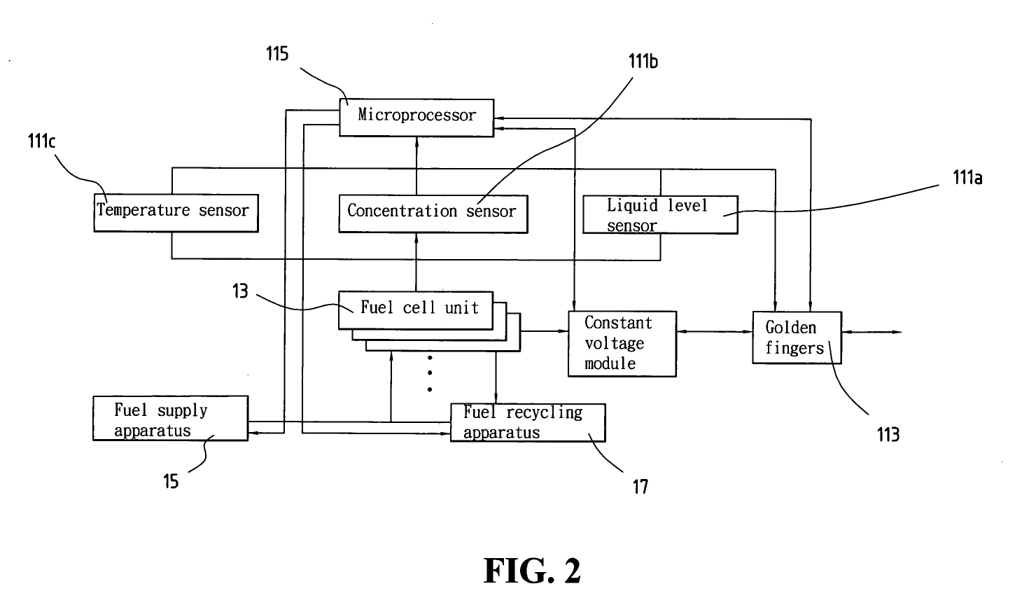

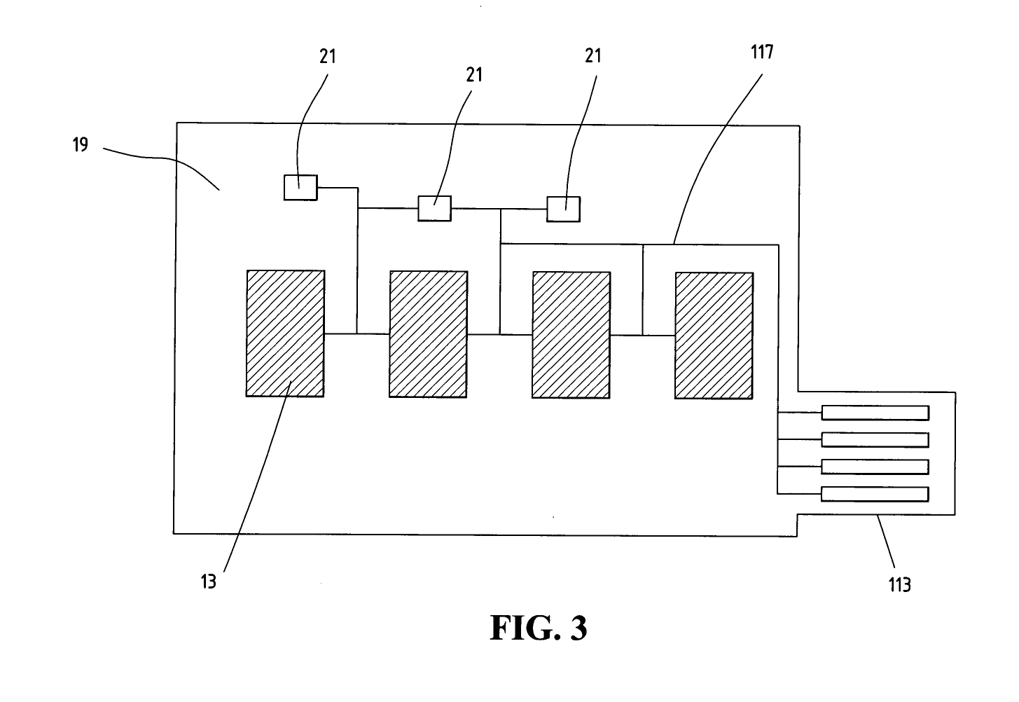

FIG. 1 shows the structural figure of the fuel cell apparatus of feedback module of the present invention, FIG. 2 shows the bock diagram of the fuel cell apparatus of feedback module of the present invention and FIG. 3 shows the embodiment of the fuel cell apparatus of the feedback module of the present invention. According to the feature of structure disclosed by FIG. 1 of the present invention, the implemented means of the present invented fuel cell apparatus 10 of feedback module, for example, utilizes the same piece of print circuit board (PCB) 19 to manufacture the fuel cell unit 13 and copper circuitry, and also solders plural active and passive electronic components 21 like the sensor, microprocessor, resistor and capacitor onto the copper circuitry to constitute the present invented energy management unit 11. Since the fuel cell apparatus 10 of the feedback module has the capability of energy management, it makes the fuel cell unit 13 able to efficiently and stably output electrical power under the monitoring of each sensor 111a, 111b, 111c and the management of microprocessor 115 and constant voltage module 119 in the process of electrochemical reaction.

In FIG. 1 to FIG. 3, fuel cell apparatus 10 of feedback module mainly comprises at least one fuel cell unit 13 and energy management unit 11 which are respectively described below. The fuel cell unit 13 acquires the supply of anode fuel and cathode fuel to produce electrical power in electrochemical reaction. Energy management unit 11 is used to manage the power efficiency produced by the fuel cell unit 13 to control anode fuel and cathode fuel into the best condition for the supply to the fuel cell unit 13.

Energy management unit 11 includes sensing module 111, I/O interface 113, microprocessor 115, electrical loop 117 and constant voltage module 119, and also electrically connects other constituents of energy management unit 11 and the fuel cell unit 13 by way of electrical loop 117. The implemented means of sensing module 11 is capable of respectively using the following sensors. Liquid level sensor 111a is used to sense the present liquid altitude of anode fuel. Concentration sensor 111b is used to sense the present concentration of anode fuel. Temperature sensor 111c is used to sense the present temperature of anode fuel and cathode fuel. These sensors 111a, 111b, 111c are capable of connecting the sensed signal to I/O interface 113 by electrical loop 117 and conducting outward, and also connecting to microprocessor 115 by electrical loop 117. The sensor devices used by sensing module 111 are possibly using the devices manufactured by micro-electromechanical system (MEMS) technology.

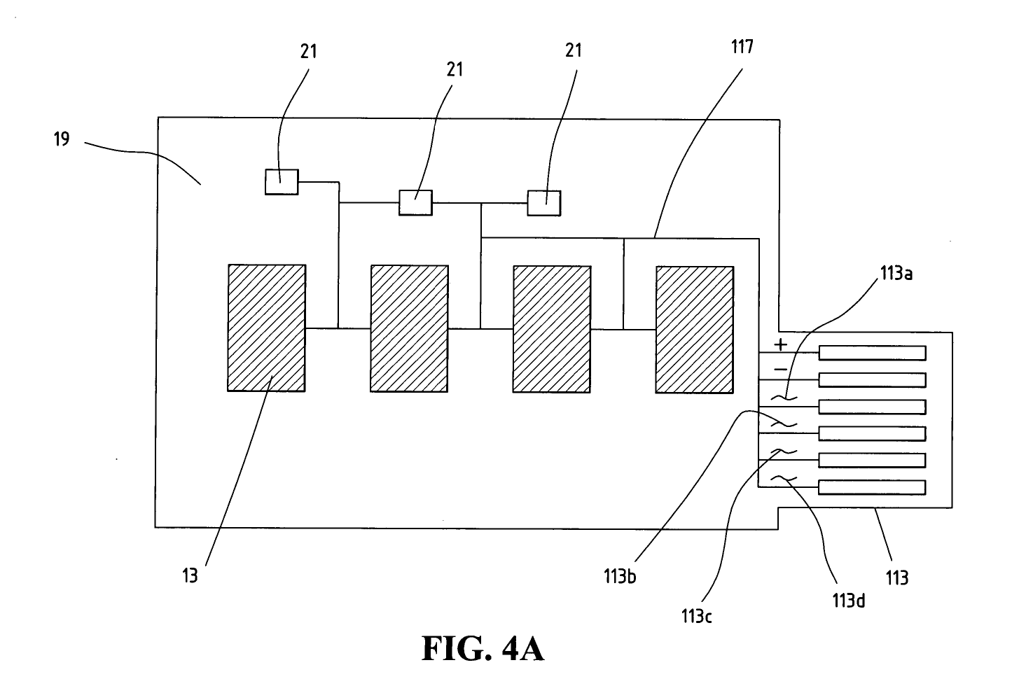

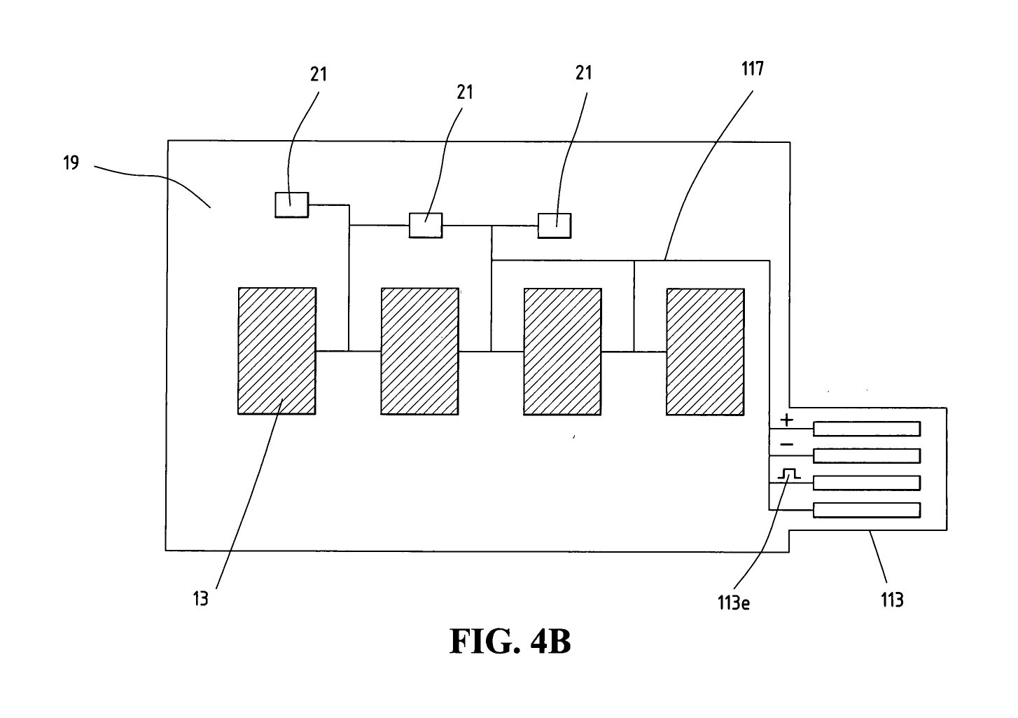

Respectively referring to the examples of I/O interface 113 shown in FIG. 4A to FIG. 4B, I/O interface 113 is used to provide a conducting path for signals and electrical power, and the implemented means is able to use the connector, golden fingers and so on. The present invented fuel cell apparatus 10 of feedback module proceeds information exchange with external electronic apparatus and equipment by I/O interface 113, and it is reasonably for the electrical power produced by the fuel cell apparatus 13 to conduct outward by I/O interface 113. The signal type conducted by I/O interface 113 is capable of being analog signal or digital signal; these signals are capable of being temperature variation signal 113a, concentration variation signal 113b, liquid level variation signal 113c or other control signal 113d. These signals are able to use I²C and SMBus as conducting means to conduct digital signals 113e which represent temperature variation information, concentration variation information, liquid level variation information and other control information. Furthermore, the symbols of (+) and (−) respectively marked in FIG. 4A to FIG. 4B are respectively represented as the positive and negative electrodes of stable voltages of power supply outputted from constant voltage module 119.

The function of microprocessor 115 is substantially to manage the fuel cell unit 13 to make the fuel cell unit 13 producing best efficiency of electrical power so as to use microprocessor for implementation. Microprocessor 115 receives the sensed signals and the signals conducted from I/O interface 113, such as the temperature variation signal, liquid level variation signal, concentration variation signal, to process the anode fuel and cathode fuel into the best condition for the supply to the fuel cell unit 13. Again, microprocessor 115 is also capable of sending a control signal to constant voltage module 119 to designate the voltage value produced by constant voltage module 119.

The implemented means of electrical loop 117 at least comprises cooper circuitry which is formed in the PCB 19. Furthermore, the present invented fuel cell apparatus 10 of feedback module also comprises fuel supply apparatus 15 and fuel recycling apparatus 17. Fuel supply apparatus 15 is equipped outside for the use of supplying anode fuel or cathode fuel to the fuel cell unit 13, and the flux of supplying anode fuel or cathode fuel is able to be controlled by microprocessor 115. Besides, fuel supply apparatus 15 is optionally equipped and electrically connected to I/O interface 113. Fuel recycling apparatus 17 is used to collect the anode fuel or cathode fuel flowing from the fuel cell unit 13 and then recycled to use again the collected anode fuel or cathode fuel. Fuel recycling apparatus 17 is optionally equipped and electrically connected to I/O interface 113. Furthermore, microprocessor 115 is capable of controlling fuel supply apparatus 15 and fuel recycling apparatus 17 to make different concentrated fuel enter the recycling.

Constant voltage module 119 is connected between the fuel cell unit 13 and microprocessor 115 to receive electrical power produced by the fuel cell unit 13 and then outputs the stable voltage of power supply which is connected to I/O interface 113. Furthermore, constant voltage module 119 and microprocessor 115 are able to be integrated as a single electronic device or respectively as the monolithic electronic device.

The present invented fuel cell apparatus 10 of feedback module is able to be applied to liquid fuel cell system like methanol fuel cell system, and gas fuel cell system like hydro-oxygen fuel cell system. Meanwhile, the present invented fuel cell apparatus of feedback module has the following advantages and improvements:
1. At least above one fuel cell unit and energy management unit are placed together onto the same PCB for the embodiment to easily achieve light, thin, short and small smart fuel cell system;
2. The fuel cell apparatus of feedback module has the feature of easy modulization and conducts information by I/O interface so as to assemble and construct the structure of multi boards for fuel cell apparatus of feedback module and also easy to be integrated into versatile powered apparatus like a notebook, mobile phone or PDA; and
3. Fuel cell apparatus of feedback module has stable voltage output of power supply so as to provide a high quality power source for powered apparatus.

Although the present invention has been disclosed as one embodiment of the above, it does not imply to limit the present invention, any person who is skilled in the art could make any change or modification within the spirit and scope of the present invention, however, it is belongs to the scope of the present invention, the protective scope of the present invention is defined by the following claims.

What is claimed is:

1. A fuel cell apparatus of feedback module, comprising:
at least one fuel cell unit;
an energy management unit, which is used to manage the power efficiency produced by the fuel cell unit, and comprising:
a sensing module, which is used to at least sense the temperature variation of the fuel, the liquid level variation of the fuel, the concentration variation of the fuel utilized in the electrochemical reaction proceeded by the fuel cell unit and used to produce the corresponding sensed signals to these variations;
an I/O interface, which is used to provide conducting paths for the signal and the electrical power;
a constant voltage module, which connects the fuel cell unit and receives the electrical power produced by the fuel cell unit and then outputs a stable preset voltage;
a microprocessor, which is used to manage the power efficiency of the fuel cell unit based on these sensed signals and the signal received from I/O interface;
an electrical loop, which is used to connect the fuel cell unit, the sensing module, the I/O interface, the constant voltage module and the microprocessor.

2. The fuel cell apparatus of feedback module according to claim 1, wherein the fuel cell unit and the energy management unit are placed together onto the same circuit board.

3. The fuel cell apparatus of feedback module according to claim 2, wherein the circuit board is the print circuit board (PCB).

4. The fuel cell apparatus of feedback module according to claim 1, wherein the I/O interface is chosen from the group consisting of a connector and a set of golden fingers.

5. The fuel cell apparatus of feedback module according to claim 1, wherein the sensing module at least comprises a temperature sensor, a liquid level sensor, a concentration sensor.

6. The fuel cell apparatus of feedback module according to claim 1, wherein the sensor device is manufactured by the micro electromechanical system (MEMS) technology.

7. The fuel cell apparatus of feedback module according to claim 1, wherein the fuel cell apparatus of feedback module further comprises a fuel supply apparatus which is used to supply the fuel to the fuel cell unit.

8. The fuel cell apparatus of feedback module according to claim 7, wherein the fuel flux supplied by the fuel cell supply apparatus is able to be controlled by the microprocessor.

9. The fuel cell apparatus of feedback module according to claim 7, wherein the fuel supply apparatus is electrically connected to the I/O interface.

10. The fuel cell apparatus of feedback module according to claim 1, wherein the fuel cell apparatus of feedback module further comprises a fuel recycling apparatus.

11. The fuel cell apparatus of feedback module according to claim 10, wherein the fuel recycling apparatus is electrically connected to the I/O interface.

12. The fuel cell apparatus of feedback module according to claim 1, wherein the fuel cell is a liquid fuel cell.

13. The fuel cell apparatus of feedback module according to claim 1, wherein the fuel cell is a gas fuel cell.

14. The fuel cell apparatus of feedback module according to claim 1, wherein the fuel cell is manufactured by the process of PCB.

15. The fuel cell apparatus of feedback module according to claim 1, wherein the constant voltage module and the microprocessor are integrated into a single electronic device.

16. The fuel cell apparatus of feedback module according to claim 1, wherein the constant voltage module and the microprocessor are respectively as the monolithic electronic device.
